(19) United States
(12) Patent Application Publication
(10) Pub. No.: US 2007/0288535 A1
(43) Pub. Date: Dec. 13, 2007

(54) Long-term data archiving system and method

(75) Inventors: Hidehisa Shitomi, Mountain View, CA (US); Manabu Kitamura, Kawasaki (JP)

Correspondence Address: SUGHRUE MION, PLLC, 401 Castro Street, Ste 220, Mountain View, CA, 94041-2007, US

(73) Assignee: HITACHI, LTD., Tokyo (JP)

(21) Appl. No.: 11/452,792

(22) Filed: Jun. 13, 2006

(51) Int. Cl. G06F 17/30

(52) U.S. Cl. 707/204

(57) ABSTRACT

Described is a long-term data archiving system. The inventive methodology provides a method for legacy applications to access long-term archived data even if the storage system access method has changed. Data from the legacy storage system is migrated to the modern storage system. During the migration, the notations associated with the data storage units within the legacy storage system are converted to the notations of the modern storage system using one or more conversion rules. In this manner, the proper location for the migrated data within the modern storage system is determined. Upon the completion of the migration, the new location of the migrated data is preserved.

### FIELD OF THE INVENTION

The invention relates generally to data storage system and more specifically to long term archiving systems.

### DESCRIPTION OF THE RELATED ART

According to the numerous existing government regulations, certain business and medical information must be stored for extended periods of time. For example, certain medical records sometimes need to be preserved for the entire lifetime of a human, which can be as long as 100 years. On the other hand, the useful life of the existing data storage media, including magnetic and optical disks or magnetic tapes, is far less than 100 years. To preserve the data, it must be migrated from one storage media to another before the expiration of the aforesaid media useful life. Moreover, it may be necessary to perform multiple aforesaid migrations.

While the data itself may be transferred to another medium, to read the data from the old medium and properly migrate it to the new medium, the appropriate software applications have to be stored and need to be restarted at the time of migration. To this end, virtual machine technologies have emerged recently. One exemplary virtual machine application is a VMware ESX Server, which is described in detail in http://www.vmware.com/pdf/esx_specs.pdf, incorporated by reference herein.

Virtual machines can emulate the execution environment of a legacy application on a modern computing platform. To utilize the legacy software application, the application environment thereof may be emulated even many years later. However, during the life of the data, the storage system access method can change from an old technology, such as SCSI protocol, to a new method, such as File access protocol. Thus, the legacy application relies on the legacy storage system access protocol, which may not be available on the modern storage/computing platform. As of now, there exists no method to transparently emulate the storage system access method change for software applications.

Therefore, what is needed is a method for legacy applications to access long-term archived data even if the storage system access method has changed. Such method may be used in conjunction with a long-term data archiving system.

### SUMMARY OF THE INVENTION

The inventive methodology is directed to methods and systems that substantially obviate one or more of the above and other problems associated with conventional techniques for long-term archiving of data.

In accordance with one aspect of inventive concept, there is provided a method for migrating data from a legacy storage system to a new storage system. The inventive method involves receiving a migration request, which includes information on a source logical unit storing the data within the legacy storage system. The inventive method further involves reading the data from the source logical unit specified in the migration request through an interface of the legacy storage system and obtaining information on the source logical unit, which includes description of a user host associated with the source logical unit. The inventive method further involves obtaining at least one conversion rule and applying the obtained conversion rule to the source logical unit information to derive information on a location of the data within the new storage system; writing the data to the derived location within the new storage system; and storing information on the written data and the location of the written data.

In accordance with another aspect of the inventive concept, there is provided a method for migrating data from a first storage system to a second storage system. The inventive method involves receiving a migration request, which includes information on a source storage address and a file path name of the data within the first storage system and reading the data specified in the migration request through a file interface of the first storage system. The inventive method further involves obtaining a location information associated with the first storage system; obtaining at least one conversion rule and applying the obtained conversion rule to the location information to derive information on a location of the data within the second storage system; writing the data to the derived location within the second storage system; and storing information on the written data comprising the location of the written data.

In accordance with yet another aspect of the inventive concept, there is provided a method for emulating an execution environment of a legacy application at a new host coupled to a new storage system. The inventive method involves receiving information on a location of a boot record of a legacy operating system and staring a virtual machine on the new host. The inventive method further involves loading a location information; using the loaded location information to translate the location of the boot record of the legacy operating system from a legacy notation to a new notation and loading the boot record of the legacy operating system from the new storage system based on the translated location.

In accordance with yet another aspect of the inventive concept, there is provided a method for executing a legacy application at a new host operatively coupled to a new storage system. The inventive method involves launching the legacy application in a virtual execution environment of the new host; intercepting at least one input-output request from the virtual execution environment, initiated by the legacy application; obtaining location information and using the location information to translate at least one location attribute associated with the intercepted input-output request from a legacy notation to a new notation. The inventive method further involves using the translated location attributes to manage data associated with the input-output requests in the new storage system and providing a response to input-output request to the virtual execution environment.

In accordance with yet another aspect of the inventive concept, there is provided a data migration system. The inventive system includes a first host executing a legacy application, a legacy storage system coupled to the legacy host and configured to store data associated with the legacy application in a source logical unit; a second host; and a modern storage system coupled to the new host. The modern storage system includes a migration module configured to receive a migration request, which includes information on the source logical unit storing the data within the legacy storage system; read the data specified in the migration request from the source logical unit through an interface of the legacy storage system; obtain information on the source logical unit, including a description of the legacy host; obtain at least one conversion rule and apply the obtained conversion rule to the source logical unit information to derive information on a location of the data within the new storage system; write the data to the derived location within the new storage system; and store information on the written data and the location of the written data.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary hardware configuration of an embodiment of the inventive system;

FIG. 2 illustrates an example of software configuration in which the method and apparatus of this invention applied;

FIG. 3 represents a conceptual diagram of an embodiment of the inventive data migration process from a legacy storage system employing a SCSI access protocol to a new storage system, which employs a file access protocol;

FIG. 4 illustrates an operating sequence of an exemplary embodiment of the inventive data migration process;

FIG. 5 illustrates an exemplary embodiment of a LUN Info Table;

FIG. 6 illustrates an exemplary embodiment of a Conversion Rule Table;

FIG. 7 illustrates an exemplary embodiment of a Location Table;

FIG. 8 represents an exemplary conceptual diagram illustrating the manner of access to the archived data by the legacy application emulated on a Virtual Machine;

FIG. 9 illustrates an exemplary control flow for recreating the execution environment of the legacy application at the new host;

FIG. 10 illustrates an exemplary operating sequence of an SCSI/File converter module;

FIG. 11 illustrates a conceptual diagram of another embodiment of the inventive system;

FIG. 12 illustrates an operating sequence of another exemplary embodiment of the inventive data migration process; and

FIG. 13 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

The inventive concept deals with a long-term data archiving system. The inventive methodology provides a method for legacy applications to access long-term archived data even if the storage system interface has changed. The inventive concept will be illustrated in detail with reference to the following exemplary embodiment thereof.

### 1. First Embodiment

The inventive concept will be illustrated herein in the context of an example of a data migration from a storage system with an access method implemented in accordance with a SCSI protocol (legacy storage system) to a storage system with a file access protocol (modern storage system). However, as would be appreciated by those of skill in the art, the inventive mechanisms are not restricted to any specific interface or interfaces of the legacy storage system and/or the modern storage system. In fact, the inventive methodology is applicable to data migration involving any two types of storage systems.

### 1.1. Exemplary System Configuration

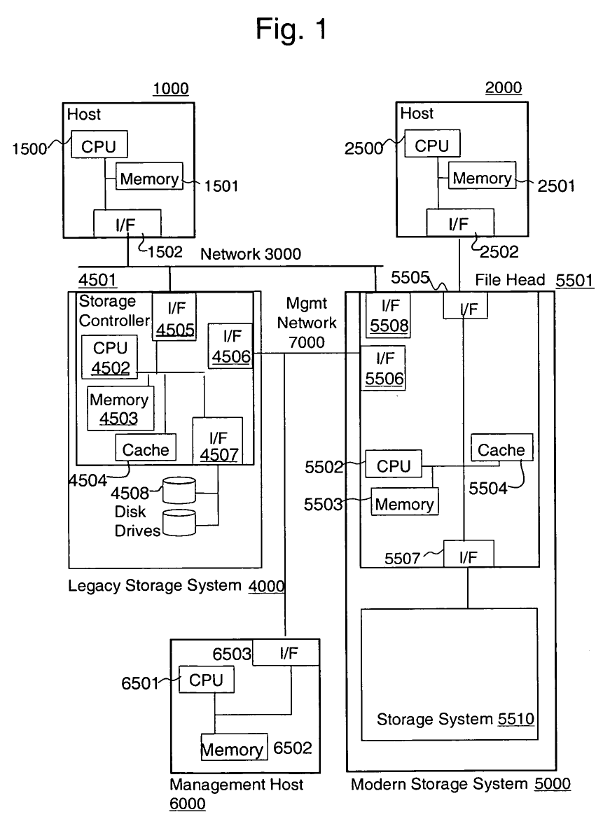

FIG. 1 illustrates an exemplary embodiment of a hardware configuration using which the inventive concept may be implemented. The shown embodiment includes a legacy Storage System 4000, which may be a block based storage system, a modern Storage System 5000, which may be a file based storage system, a Host 1000 connected to the legacy Storage System 4000, a Host 2000 connected to the modern Storage System 5000, and a Management Host 6000.

The Legacy Storage System 4000 includes a Storage Controller 4501 coupled to a set of Disk Drives 4508. The storage controller 4501 comprises a CPU 4502, memory 4503, cache memory 4504, host interface 4505, management interface 4506, and disk interface 4507. The storage controller processes input-output (I/O) requests received from the host 1000.

Memory 4503 of the controller 4501 of the legacy storage system 4000 stores a software program, which handles I/O operations associated with the data stored in the legacy storage system. The aforesaid program is executed by the CPU 4502 of the legacy storage controller 4501. The cache memory 4504 temporally stores the data written to the legacy storage system by the host 1000, before these data is stored to the disk drives 4508. The cache memory may also temporally store the read data that are requested by the host 1000. The cache may be implemented as a battery backed-up non-volatile memory, which would protect the cached data against power failure. In another implementation, the memory 4503 and the cache memory 4504 are combined within the same memory unit.

The host interface 4505 provides a networking connection capability between the host 1000 and the controller 4501. The Fibre Channel (FC) and Ethernet protocols are two exemplary protocols, which may be utilized in establishing the aforesaid connection between the host and the controller. The management interface 4506 is used by the management host 6000 to connect to and to manage the storage controller 4501. The disk drive interface 4507 is provided to interconnect the disk drives 4508 with the storage controller 4501. Each of the Disk Drives 4508 processes the input and output (I/O) requests received by the legacy storage system 4000 in accordance with the SCSI Device command set, well known to persons of skill in the art.

The modern Storage System 5000 includes two main components—the File Head 5501 and the Storage System 5510. The File Head 5501 and the storage system 5510 can be connected via the interface 5507. The file head 5501 and the storage system 5510 may be implemented within one storage unit. In such an implementation, the aforesaid two elements may be connected via a system bus, such as PCI. In another implementation, the file head and the storage system may be physically separated. In this case, the aforesaid two elements may be interconnected via network connections such as Fibre Channel or Ethernet.

The file head 5501 includes a CPU 5502, memory 5503, cache memory 5504, front-end network interface (NIC) 5505, management interface 5506, disk interface (I/F) 5507, and inter storage network interface 5508. The file head processes various requests from the host 2000 and the management host 6000.

Similar to the legacy storage system, the memory 5503 of the file head 5501 of the modern storage system 4000 stores a software program, which handles I/O operations associated with the data stored in the modern storage system. The aforesaid program is executed by the CPU 5502 of the file head 5501.

Cache 5504 temporally stores data written from the host 2000 before the data is forwarded to the storage system 5510, or it stores read data that are requested by the host 2000. The cache may be implemented as a battery backed-up non-volatile storage unit. In another implementation, memory 5503 and cache memory 5504 are combined with the same memory unit. The front-end interface 5501 is used to establish a data connection between the host 2000 and the file head 5501. One common implementation of the front-end interface 5501 is an interface based on the Ethernet protocol, well known to persons of skill in the art.

Management interface 5506 is used by the management host to manage the File Head 5501 and the storage system 5510. Disk interface 5507 is provided to enable the data transfer between the file head 5501 and the storage system 5510. The Fibre Channel (FC) and Ethernet are two typical examples of protocols, which may be used in implementing of the interface 5507. In the case of an internally implemented connection between the file head and the storage system, a system bus-type interface may be used in implementing such a connection.

Inter storage network interface 5508 is provided to interconnect the file head 5501 to the old storage system 4000. The storage system 5510 has a similar hardware configuration to the storage system 4000. It processes I/O requests from the File Head 5501. The same legacy software application executes on both the host 1000 and the host 2000. This application is not shown in FIG. 1. The application code is stored in the memory units 1501 and 2501, and is executed by the CPU 1500 and 2500. The application accesses the data stored in the Storage Systems 4000 or new Storage System 5000 using interfaces 1502 and 2502. The hosts and storage systems can be interconnected via a data network such as network 3000.

Management Host 6000 executes management software (not shown in FIG. 1), which is stored in the memory 6502, and is running on the CPU 6501. The Management Host is connected to the old Storage Systems and new Storage System via interface 6503 coupled to the management network 7000. As would be appreciated by those of skill in the art, the inventive concept is not limited to the described hardware architecture and other appropriate hardware configurations can be used to implement the invention.

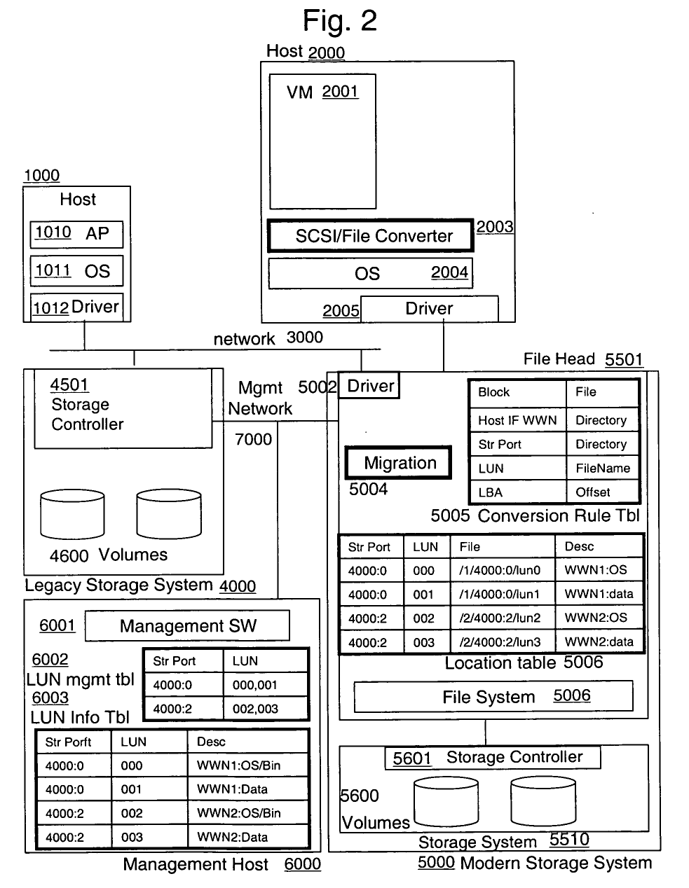

FIG. 2 illustrates an exemplary software configuration to which the method and apparatus of this inventive methodology may be applied. The system is composed of a legacy Storage System 4000 such as a block based storage system, a modern Storage System 5000 such as a file based storage system, a Host 1000 connected to the legacy Storage System 4000, a Host 2000 connected to the modern Storage System 5000, and a Management Host 6000.

The Legacy Storage System 4000 may incorporate a storage controller 4501, which processes SCSI commands sent by the host 1000. Volumes 4600 may each be composed of one or more disk drives 4508. The modern Storage System 5000 incorporates two main components—file head 5501 and storage system 5510.

The file head 5501 processes file-related operations directed to the modern storage system 5000. The local file system 5106 of the modern storage system 5000 processes file I/O operations initiated from the host 2000. Specifically, the local file system 5106 translates the file I/O operations to the block level operations, and communicates with the storage system 5510 via SCSI commands. A migration module 5004 is operable to read data from another storage system, such as the storage system 4000 using an appropriate I/O driver 5002, such as a SCSI driver, and to write the read data to the storage system 5510 via the file system 5106. During the writing operation, the migration module 5004 utilizes the conversion rule table 5005 to determine the manner of data placement within the storage system 5510. The conversion rule table 5005 may be manually populated by a storage system administrator from the storage management host 6000. The aforesaid table may be physically stored within the storage system 5510. After finishing the data migration, the migration module 5004 stores the new location of the migrated data in the location table 5006. The location table 5006 may be also physically stored in the storage system 5510.

The storage system 5510 will now be described. The storage controller 5601 processes SCSI commands from the file head 5501. File systems for storing data in the file format are created on volumes 5600 of the storage system 5510.

The host 1000 is a computer platform executing the legacy application (AP) 1010 running under an OS 1011. The legacy application may generate I/O operations addressed to the legacy storage system 4000. The communication between the application 1010 and the legacy storage system 4000 is accomplished by means of a software driver 1012. The host 1000 and the storage system 4000 are interconnected via a network 3000, such as a storage area network based on the fibre channel protocol (FCP) well known to persons of skill in the art. The host 1001 is generally similar to the host 1000. It incorporates legacy application 1020, OS 1021 and software driver 1022.

Host 2000 is a computer platform on which the virtual machines (VM) 2001 and 2002 are executed under the OS 2004. Each VM emulates the execution environment of the legacy application. Using the VM 2001, a software application originally designed for a legacy execution environment, such as the environment of the host 1000, can be executed without any modification. An application running on the VM 2001 also generates I/O operations. However, these I/O operations generated by a legacy application running on a virtual machine do not necessarily match the data access protocol of the modern storage system 5510. Therefore, the SCSI/File converter module 2003 converts the I/O operations from the legacy data access format to the data access format used in the modern storage system. The driver program 2005 communicates with the modern storage system 5000 and transmits the I/O operations initiated by the application running under the VM 2001. The host 2000 and the storage system 5000 are interconnected via a network such as Ethernet or FC.

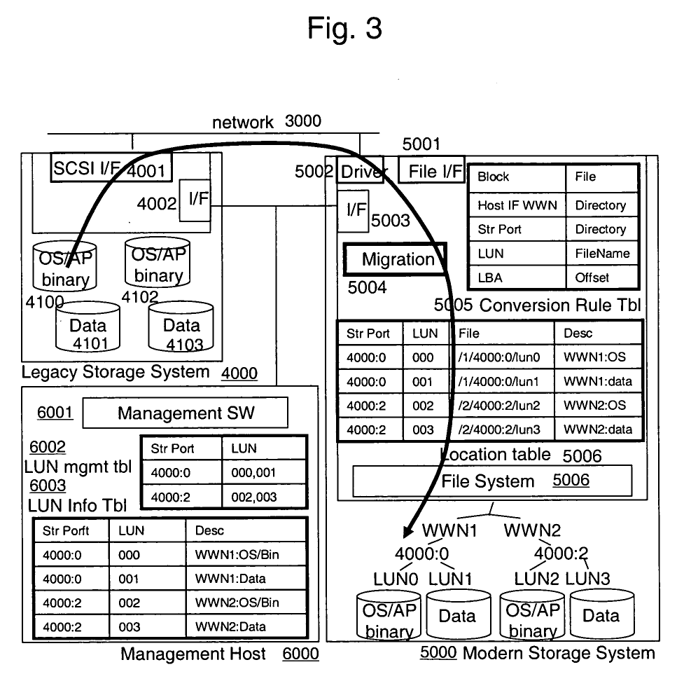

The management host 6000 will now be described. The management host 6000 is coupled to the legacy storage system 4000 via management interface 4002 and to the modern storage system 5000 via management interface 5003, see FIG. 3. The management software 6001 resides on the management host 6000. The management host 6000 is connected to storage systems 4000 and 5000 via a management network 7000, such as Ethernet. Storage management operations are being initiated by the management software. The management software 6001 additionally manages storage configuration information tables, which are stored on the local disks of management host 6000. The aforesaid storage configuration information tables include the logical unit number (LUN) management table 6003, which includes information on the LUN and port mapping and the LUN information table 6003, containing the LUN content description. The LUN management table 6002 can be created during the path definition phase of the storage system configuration. The LUN information table 6003 may be manually populated by the storage system administrator. It may be physically stored in the local disks of the management host 6000.

### 1.2. Migration Process

FIG. 3 represents a conceptual diagram of an embodiment of the data migration process from a legacy storage system, which employs, for example, a SCSI protocol for accessing the stored data, to a modern storage system, which employs, for example, a file access protocol for stored data access.

At the end of life of the legacy storage system 4000, a storage administrator migrates OS/application binary code and data stored in the logical units 4100-4103 of the legacy storage system 4000 to a modern storage system 5000. To this end, the administrator utilizes storage management software 6001 executing on the storage management host 6000 to invoke a migration module 5004 on the modern storage system 5000.

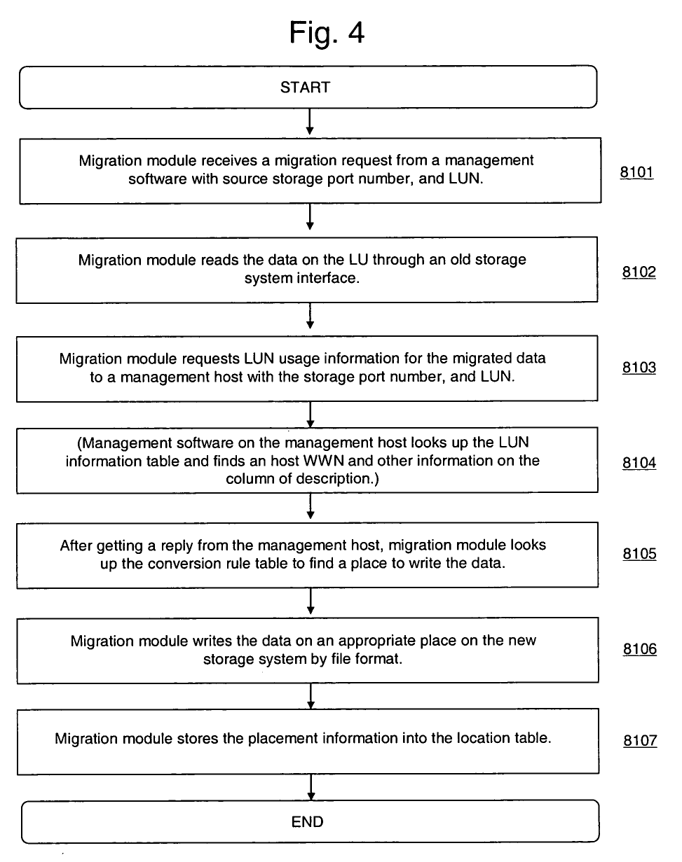

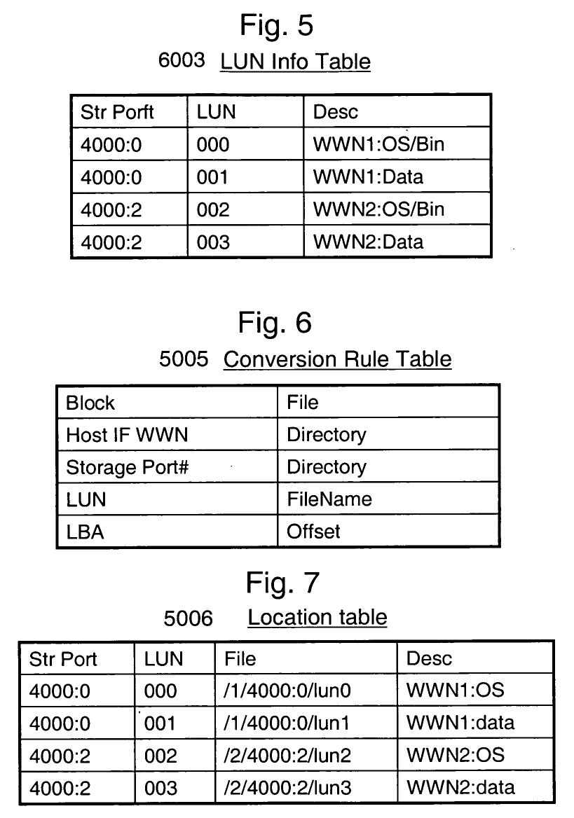

FIG. 4 illustrates an operating sequence of an exemplary embodiment of the data migration process, which may be performed, in whole or in part, by the migration module 5004.
1. Initially, at step 8101, the migration module 5004 receives a migration request from the management software 6001. The migration request may specify the data to be migrated by providing a source storage port number (4000:0), and an LUN (000) identifying the location of the source data. The storage port number can be a WWN address for the storage port interface 4001.
2. At step 8102, the migration module reads the source data from the LU (000) designated in the migration request through the storage system interface 4001 of the legacy storage system 4000.
3. At step 8103, the migration module requests the LUN usage information associated with the source LUN. The usage information request is sent by the migration module 5004 to the management software 6001 with port number (4000:0) and LUN (000).
4. In response to the received LUN usage information request, at step 8104, the management software 6001 residing on the management host 6000 looks up the LUN information table 6003 stored at the management host 6000 and fetches the designated LUN information. The fetched information may include, without limitation, the WWN of the host as well as the data usage information indicating whether the migrated data represents an operating system/application binary code or any other types of data. This information may be contained in the description column of the LUN information table 6003. As stated before, the LUN information table 6003 may be manually populated by a storage system administrator. FIG. 5 illustrates an example of the LUN information table. The typical information in the table includes a storage port number, LU number (LUN), and description. The storage port number and LUN information can be automatically populated based upon the information in the LUN management table 6002 at the time the corresponding entries are created in the LUN management table 6002. The LUN management table 6002 can be created during the path definition phase of the storage system configuration. The information in the description column of the table, which may include the host name and the data usage information (OS/AP binary or data) may be manually input by the storage administrator at some point after the storage name, storage port, and LUN entries are created.
5. After getting a reply from the management software 6001, at step 8105, the migration module 5004 looks up the conversion rule table 5005 to find a location to write the data. The conversion rule table 5005 may also be manually populated by the storage administrator using the storage management software 6001. FIG. 6 illustrates an example of the conversion rule table 5005. As stated above, the described example involves conversion from the SCSI protocol to the File access protocol. As for the SCSI protocol, the data in a block device can be specified with a host interface WWN, storage port number, LUN, and LBA. Each data unit written in accordance with the SCSI protocol can correspond to some data unit of the File access protocol by the rule specified in the aforesaid conversion rule table.
6. According to the conversion rule, at step 8106, the migration module writes the migrated data to an appropriate location on the modern storage system using a specific file format corresponding to the aforesaid usage of the source data. For example, the LU 4100 containing the OS/Application binary associated with host1 1000 (NWN1) can be placed in a file named “/1/4000:0/LUN0”, because the host name associated with the LU 4100 is WWN1, storage port number is 4000:0, and LUN of the LU 4100 is 0.
7. At step 8107, the migration module stores the location information of the migrated data into the location table 5006. FIG. 7 illustrates an example of the location table 5006. Exemplary entries of the table 5006 include storage port mapped to the LU, LU number, file location, and the data usage descriptions.

### 1.3. Data Access Process from an Application

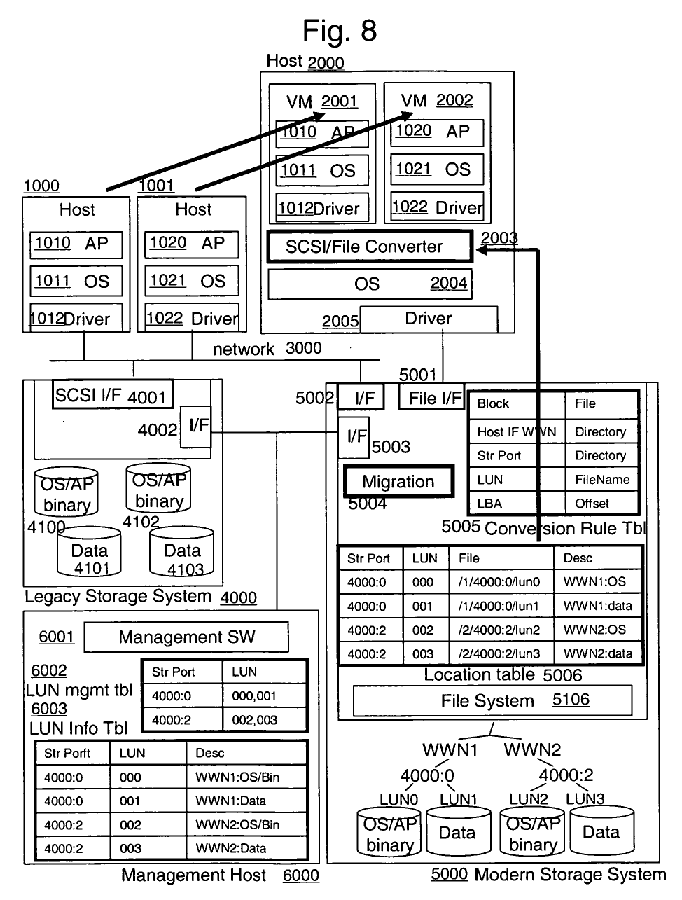

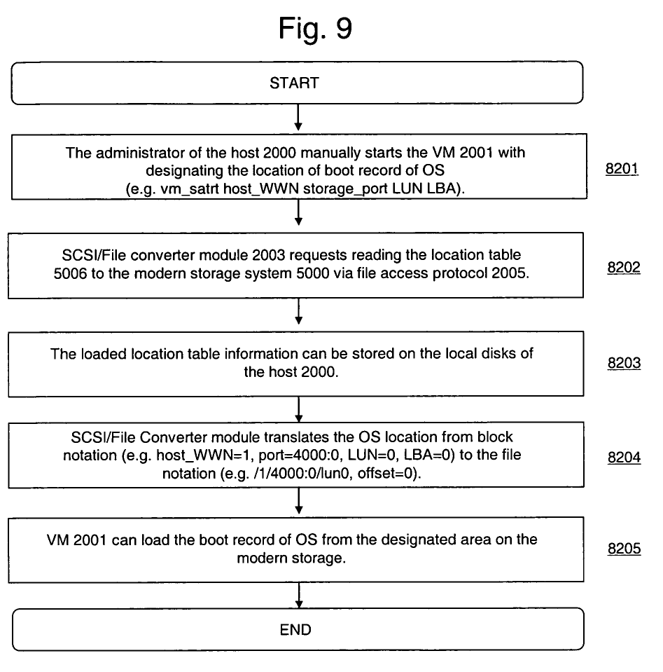

FIG. 8 represents a conceptual diagram illustrating the manner of access to the archived data from the legacy application emulated on a virtual machine 2001. The computational environment of the legacy application 1010 is migrated to the modern host 2000 by deploying the application 1010 on a virtual machine 2001 executing on the modern host 2000. Due to the utilization of the virtual execution environment provided by the virtual machine 2001, no changes are needed to be made in the original application 1010, operating system 1011, and drivers 1012. FIG. 9 illustrates a control flow for recreating the execution environment of the legacy application at the modern host 2000.
1. First, at step 8201, the administrator of the host 2000 manually starts the VM 2001 by designating the location of the boot record of the OS (e.g. vm_satrt host_WWN storage_port LUN LBA).
2. Then, at step 8202, the SCSI/File converter module 2003 requests reading the location table 5006 to the new storage system 5000 via the file access protocol 2005. The location table loading can be requested through a proprietary interface command between the SCSI/File Converter module 2003 and the modern Storage Systems 5000. The loaded location table information can be stored on the local disks of the host 2000, at step 8203.
3. Then, at step 8204, the SCSI/File Converter module translates the OS location from the block notation (e.g. host_WWN=1, port=4000:0, LUN=0, LBA=0) to the file notation (e.g. /1/4000:0/lun0, offset=0).
4. Then, the virtual machine 2001 can load the boot record of the legacy OS from the designated area on the modern storage system, see step 8205.

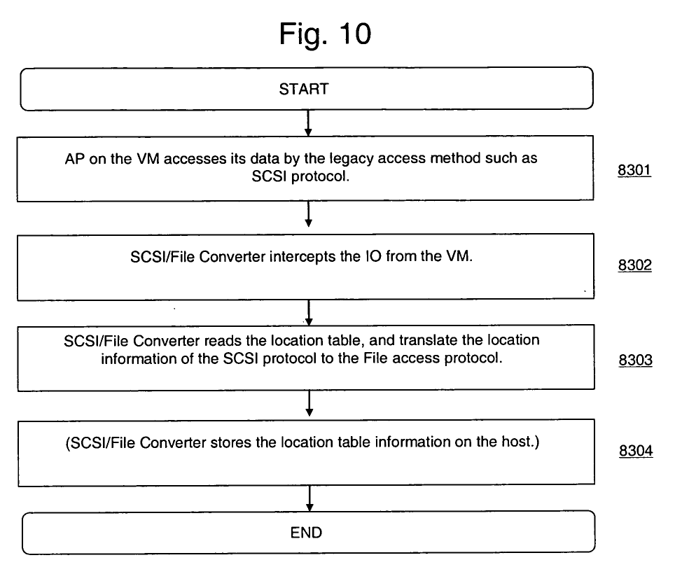

After configuring the original application environment by VM 2001, the legacy application execution under VM 2001 proceeds to issue I/O operations requesting the data stored in the modern storage system. FIG. 10 shows an exemplary control flow of the SCSI/File converter module 2003, which processes each I/O operation of the application.
1. The legacy application 1010 on the virtual machine 2001 issues a data access request to accesses data using the legacy access method, such as SCSI protocol 1012, see step 8301.
2. At step 8302, the SCSI/File Converter 2003 intercepts the IO from the virtual machine 2001.
3. The SCSI/File Converter reads the location table saved in the local disk of the host 2000, and translates the location information of SCSI protocol to the file access protocol information, see step 8303 in FIG. 10.
4. If the location information table is not saved at the time of the start of the virtual machine, the SCSI/File Converter can read the location table information from the modern storage system 5000 and store it in the host 2000, see step 8304. Instead of saving the location table on the host, it is also possible for SCSI/File converter module 2003 to read the location information table during each I/O operation.

### 2. Second Embodiment

### 2.1. The Third Generation Storage

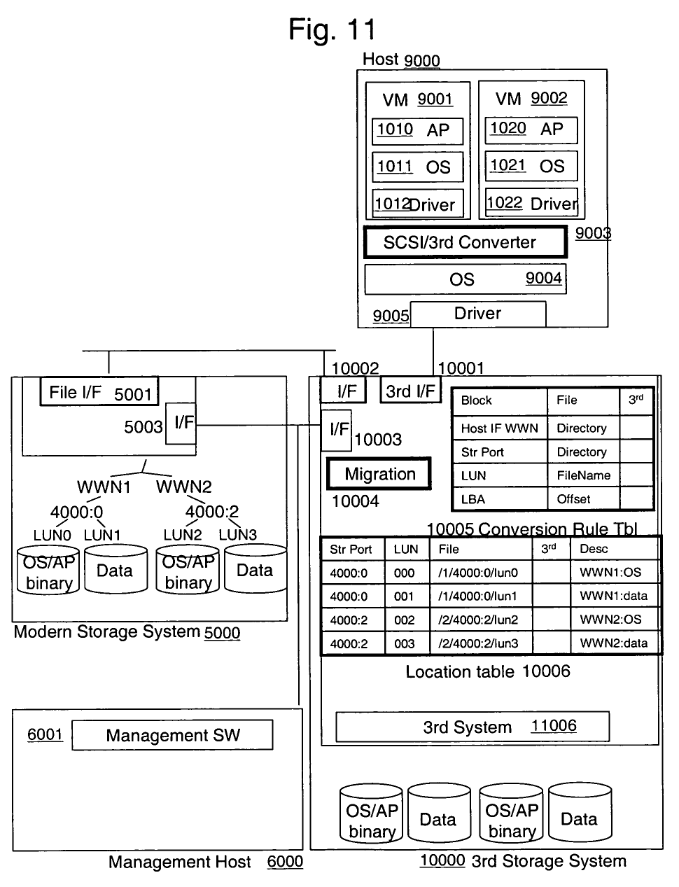

As would be appreciated by persons of skill in the art, another storage interface transition may take place during the term of archiving of the data in the modern storage system 5000. Specifically, a technology transition may take place to a third generation data access interface, such as, an object-based interface. FIG. 11 illustrates a conceptual diagram of data migration to a storage system based on such third generation data access method. In this example, most of the data migration and data access procedures are the same as the procedures described hereinabove with reference to the first embodiment. The differences are provided in the following description. Specifically, in the embodiment shown in FIG. 3, host 9000 executes virtual machines 9001 and 9002, which emulate the legacy execution environments of the legacy applications 1010 and 1020. The aforesaid virtual machines are executed on the host 9000 using the OS 9004. The third generation storage system 10000 is coupled to the management host 6000 using the management interface 10003. The interconnection of the third generation storage system 10000 to the new storage system 5000 and the host 9000 for purposes of data transfer is accomplished by means of interfaces 10002 and 10001, respectively.

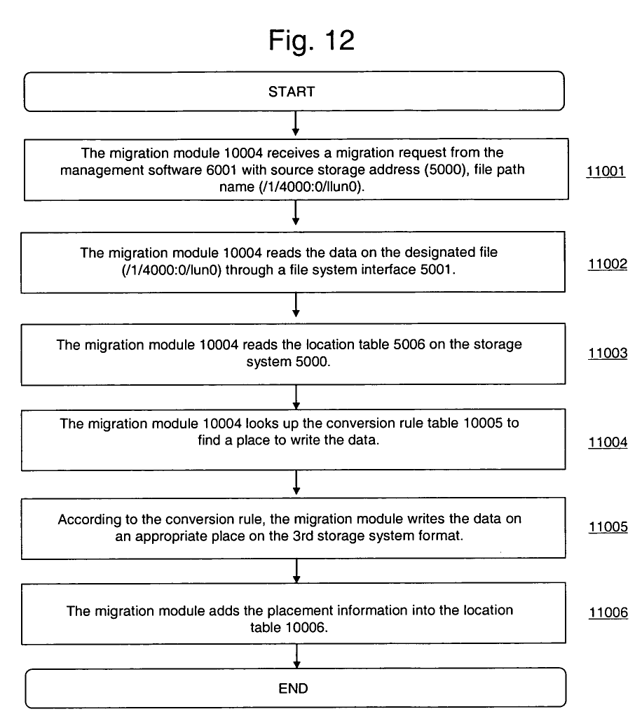

In accordance with the migration process illustrated in FIG. 12,
1. At step 11001, the migration module 10004 receives a migration request from the management software 6001 with an associated source storage address (5000), file path name (/1/4000:0/lun0).
2. At step 11002, the migration module 10004 reads the data from the designated file (/1/4000:0/lun0) on the storage system 5510 through a file access interface 5001.
3. The migration module 10004 reads the location table 5006 on the storage system 5000, see step 11003.
4. At step 11004, the migration module 10004 looks up the conversion rule table 10005 to find a location to write the migrated data. The conversion rule table 10005 may be manually populated by the storage administrator using the storage management software 6001. The new information for the 3rd generation storage system must have been added at the time of the migration.
5. According to the conversion rule, at step 11005, the migration module writes the data to the appropriate location on the storage system 11006 in accordance with the 3rd generation storage system format.
6. The migration module adds the data location information into the location table 10006, see step 11006.

In the control flow associated with the reconstruction of the legacy application environment at host 9000, the SCSI/3rd generation converter module 9003, instead of the SCSI/File converter module, requests the reading of the location table 10006 to the new storage system 10000 via the 3rd generation interface 9005.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized storage system with data replication functionality. It is intended that the specification and examples be considered as exemplary only, with a true scope and spirit of the invention being indicated by the following claims.

What is claimed is:

1. A method for migrating data from a legacy storage system to a new storage system, the method comprising:
a. Receiving a migration request, the migration request comprising information on a source logical unit storing the data within the legacy storage system;
b. Reading the data from the source logical unit specified in the migration request through an interface of the legacy storage system;
c. Obtaining information on the source logical unit, the source logical unit information comprising a description of a user host associated with the source logical unit;
d. Obtaining at least one conversion rule and applying the obtained conversion rule to the source logical unit information to derive information on a location of the data within the new storage system;
e. Writing the data to the derived location within the new storage system; and
f. Storing information on the written data and the location of the written data.

2. The method of claim 1, wherein the migration request identifies a storage port number associated with the source logical unit and a logical unit number of the source logical unit.

3. The method of claim 1, wherein the source logical unit information is obtained from a logical unit information table.

4. The method of claim 3, wherein the logical unit information table comprises a storage port number information, a logical unit number information, a host name information and a data usage information.

5. The method of claim 4, wherein the data usage information indicates whether the data is an operating system or application binary or a text data.

6. The method of claim 3, wherein the logical unit information table is manually populated by a storage administrator.

7. The method of claim 1, wherein obtaining source logical unit information comprises:
a. Sending a request to a management software, the request identifying the source logical unit; and
b. Receiving a response from the management software, the response comprising the logical unit information for the source logical unit.

8. The method of claim 1, wherein the information on the location of the written data is stored into a location table comprising a host name associated with the logical unit, storage port mapped to the logical unit, an identifying number of the logical unit, file location, and a file usage description.

9. The method of claim 1, wherein the migration request comprises a source storage port number and a logical unit number of the data in the legacy storage system.

10. The method of claim 1, wherein the legacy storage system is a block based storage system and the new storage system is a file based storage system.

11. The method of claim 1, wherein the obtaining of at least one conversion rule comprises looking up data location information in the new storage system from a conversion rule table comprising mapping between data storage attributes in the legacy storage system and the new storage system.

12. The method of claim 1, therein the information on the written data and the location of the written data is stored in a location table.

13. The method of claim 12, wherein the written data is stored to the new storage system as a data file and wherein the location table comprises information on a name of the data file, a path of the data file, a storage port number associated with the source logical unit and a logical unit number of the source logical unit.

14. The method of claim 1, further comprising executing a legacy application and providing the written data in response to input-output requests from the legacy application.

15. The method of claim 14, wherein providing further comprises translating location information associated with the input-output request from legacy notation to new notation based on a content of a location table.

16. The method of claim 1, therein the legacy storage system is a file based storage system and the new storage system is an object based storage system.

17. A method for migrating data from a first storage system to a second storage system, the method comprising:
a. Receiving a migration request, the migration request comprising information on a source storage address and a file path name of the data within the first storage system;
b. Reading the data specified in the migration request through a file interface of the first storage system;
c. Obtaining a location information associated with the first storage system;
d. Obtaining at least one conversion rule and applying the obtained conversion rule to the location information to derive information on a location of the data within the second storage system;
e. Writing the data to the derived location within the second storage system; and
f. Storing information on the written data comprising the location of the written data.

18. A method for emulating an execution environment of a legacy application at a new host operatively coupled to a new storage system, the method comprising:
a. Receiving information on a location of a boot record of a legacy operating system;
b. Staring a virtual machine on the new host;
c. Loading a location information;
d. Using the loaded location information to translate the location of the boot record of the legacy operating system from a legacy notation to a new notation;
e. Loading the boot record of the legacy operating system from the new storage system based on the translated location.

19. The method of claim 18, wherein the location information is loaded from a location table.

20. A method for executing a legacy application at a new host operatively coupled to a new storage system, the method comprising:
a. Launching the legacy application in a virtual execution environment of the new host;
b. Intercepting at least one input-output request from the virtual execution environment, the input-output request being initiated by the legacy application;
c. Obtaining location information;
d. Using the location information to translate at least one location attribute associated with the intercepted input-output request from a legacy notation to a new notation;
e. Using the translated location attributes to manage data associated with the input-output requests in the new storage system; and
f. Providing a response to input-output request to the virtual execution environment.

21. The method of claim 20, further comprising storing the obtained location information on the new host.

22. The method of claim 20, wherein managing comprises reading the data associated with the input-output request and wherein providing the response comprises providing the read data to the virtual execution environment.

23. A data migration system comprising:
a. A first host operable to execute a legacy application;
b. A legacy storage system operatively coupled to the legacy host and operable to store data associated with the legacy application in a source logical unit;
c. A second host; and
d. A modern storage system operatively coupled to the new host; and
comprising a migration module operable to:
i. receive a migration request, the migration request comprising information on the source logical unit storing the data within the legacy storage system;
ii. read the data specified in the migration request from the source logical unit through an interface of the legacy storage system;
iii. obtain information on the source logical unit, the source logical unit information comprising a description of the legacy host;
iv. obtain at least one conversion rule and apply the obtained conversion rule to the source logical unit information to derive information on a location of the data within the new storage system;
v. write the data to the derived location within the new storage system; and
vi. store information on the written data and the location of the written data.

24. The system of claim 23, further comprising a management host operable to send the migration request, wherein the migration request identifies a storage port number associated with the source logical unit and a logical unit number of the source logical unit.

25. The system of claim 24, wherein the management host comprises a logical unit information table storing the source logical unit information.

26. The system of claim 25, wherein the logical unit information table comprises a storage port number information, a logical unit number information, a host name information and a data usage information.

27. The system of claim 26, wherein the data usage information indicates whether the data is an operating system or application binary or a text data.

28. The system of claim 25, wherein the management host comprises a management software operable to receive an input from an administrator and populate the logical unit information table based on the received input.

29. The system of claim 23, wherein during the obtaining of the source logical unit information, the migration module is operable to:
a. Send a request to a management software, the request identifying the source logical unit; and
b. Receive a response from the management software, the response comprising the logical unit information for the source logical unit.

30. The system of claim 23, wherein the new storage system comprises a location table operable to store placement information and wherein the location table comprises a host name associated with the logical unit, storage port mapped to the logical unit, an identifying number of the logical unit, file location, and a file usage description.

31. The system of claim 23, wherein the migration request comprises a source storage port number and a logical unit number of the data in the legacy storage system.

32. The system of claim 23, therein the legacy storage system is a block based storage system and the new storage system is a file based storage system.

33. The system of claim 23, wherein the new storage system comprises a conversion rule table comprising a mapping between data storage attributes in the legacy storage system and the new storage system.

34. The system of claim 23, further comprising a location table storing information on the written data and the location of the written data.

35. The system of claim 34, wherein the migration module is further operable to store the written data to the new storage system as a data file and wherein the location table comprises information on a name of the data file, a path of the data file, a storage port number associated with the source logical unit and a logical unit number of the source logical unit.

36. The system of claim 23, wherein the new host system is operable to execute a legacy application and wherein the new storage system is operable to provide the written data in response to input-output requests from the legacy application.

37. The system of claim 36, wherein the new host system further comprises a converter module operable to translate location information associated with the input-output request from legacy notation to new notation based on a content of a location table.

38. The system of claim 23, therein the legacy storage system is a file based storage system and the new storage system is an object based storage system.
